(19) United States
(12) Patent Application Publication
(10) Pub. No.: US 2013/0040751 A1
(43) Pub. Date: Feb. 14, 2013

(54) METHOD AND APPARATUS FOR SELECTING THE PROPER SIZE OF A GOLF CLUB FOR A SPECIFIC GOLFER

(71) Applicant: Larry M. Wise, Center Valley, PA (US)

(72) Inventor: Larry M. Wise, Center Valley, PA (US)

(21) Appl. No.: 13/209,363

(22) Filed: Aug. 12, 2011

Related U.S. Application Data
(63) Continuation-in-part of application No. 13/208,335, filed on Aug. 11, 2011, now abandoned.

(51) Int. Cl. A63B 53/00; B23P 17/00

(52) U.S. Cl. 473/287; 29/407.05; 473/409

(57) ABSTRACT

A method and apparatus for providing a golfer with a set of clubs that are each configured to match the golfer's specific hand height. A measuring club can be used to measure the golfer's hand height, which can then be adjusted (decreased by a constant amount) to account for bending at the pelvic waist. Any number and type of golf clubs can then be made for the golfer by determining a lie angle and club length that all match the adjusted hand height. Sets of clubs, each set configured for a particular adjusted hand height, can also be stocked by a store and sold to a customer (golfer), the golfer receiving a set that matches his/her adjusted hand height. In this manner, the golfer can use all of these constant hand height clubs without having to change his or her stance for each of the clubs since the clubs are all configured to match the hand height of the golfer.

### CROSS REFERENCE TO RELATED APPLICATIONS

This application I is a continuation in part of application Ser. No. 13/208,335 which is incorporated by reference herein in its entirety.

### FIELD OF THE INVENTION

The present inventive concept is a system, method and apparatus for determining the proper golf club for a golfer.

### BACKGROUND

With a few minor exceptions, golfers are expected to adjust themselves to fit their golf clubs rather than adjust their clubs to fit themselves. Typically, the adjustments required by golfers of varying sizes and shapes to conform to their clubs require the golfer to stand in awkward and unnatural positions at varying bends in the knees, elbows and spine. Not surprisingly, swinging a golf club while standing in such awkward positions can lead to a lack of control and an increased number of variables regarding the golfer's stance, hindering his or her ability to achieve a consistent swing. Furthermore, the stances required for each club are slightly different, meaning that multiple stances must be mastered by the golfer in order to effectively use a complete set of golf clubs.

Prior art golf clubs have standard configurations. The table below illustrates example parameters of different golf clubs.

| | | | Medium | Long |
|---|---|---|---|---|
| Club | Loft° | Lie° | Length″ | Length″ |
| putter | 3 | 72 | 35 | 37 |
| Pitching | 48 | 70 | 35 | 35.5 |
| wedge | | | | |
| 9 iron | 45 | 65 | 35.5 | 36 |
| 8 iron | 40 | 64 | 36 | 36.5 |
| 7 iron | 35 | 63 | 36.5 | 37 |
| 6 iron | 30 | 62 | 37 | 37.5 |
| 5 iron | 25 | 61 | 37.5 | 38 |
| 4 iron | 20 | 60 | 38 | 38.5 |
| 3 iron | 15 | 59 | 38.5 | 39 |
| 2 iron | 10 | 58 | 39 | 39.5 |
| 4 wood | 14-16 | 52 | 41 | 42 |
| 3 wood | 13-15 | 50 | 42 | 43 |
| 2 wood | 11-13 | 48 | 43 | 44 |
| driver | 8-11 | 46 | 44 | 45 |

A stance that is taken prior to finding a measurement may not be the best position for the golfer in terms of correct form or ability to be consistently repeated. Thus, the measurements that are taken when a golfer is in this position may not be correct. Generally, these methods require the golfer to determine which position feels correct. A correct feeling may be based on past habits that do not actually provide the most effective golf swing. Additionally, many times the correct club for a golfer is chosen by feel alone. This perpetuates any poor habits that have been developed prior to this fitting.

None of these existing methods allow the golfer to achieve a neutral body balanced position, which would allow for the most comfortable and anatomically correct swing.

Each of the golf clubs in a typical golf club set has a different length, lie angle and loft angle. These variations require the golfer to adjust his or her stance and body placement with each swing that requires the use of a different club. A greater number of variables in the swing decreases consistency and reduces the ability of a golfer to repeat the same swing and improve with practice. The prior methods require that the golfer learn a different swing for each of the clubs, requiring a greater amount of time to improve each swing.

What is needed is a system to determine the proper size for a golf club or set of golf clubs for a particular golfer that takes into account the anatomical properties of that specific golfer and allows him or her to maintain a neutral body balance position through his or her swing.

The lie angle of a golf club is the angle formed between the head and the shaft of the club. A combination of the lie angle and the club length determines the distance the golfer must stand from the ball in order to hit it properly. The best swing is one where the length of the head of the club is parallel to the ground and the radius of the swing circle is aligned with the swing center located between the golfer's shoulders.

The typical golfer tends to lean too far forward in his or her stance and reaches too far out to the ball when addressing the ball. This awkward stance does not allow the golfer to achieve the best swing due to improper balance, which takes energy away from the swing to assist the golfer to not fall over and greatly increases the chance that the golfer will miss-hit the ball. This improper stance is necessitated by the golf clubs that are currently in use. Today's clubs are too short and too flat in lie for the players and require them to lean over and reach for the ball in order to hit it. A longer club length and corresponding lie angle can allow the golfer to address the ball in a neutral body balanced position, as well as maintain a swing circle with the center located directly between the golfer's shoulders.

Most sets of golf clubs are purportedly fitted to an average golfer and are not adaptable to each individual. Additionally, each club in the set has a different length, weight, hand height, lie and loft angle. These differences among the clubs require the golfer to develop a different posture and swing for each club. This increases the likelihood that the golfer will not be able to reproduce a correct or effective swing each time he or she addresses the golf ball. Furthermore, most golf clubs found on the market today are too short and too flat in lie angle, causing the golfer to make further adjustments in order to properly swing each club.

Prior art that has attempted to deal with this issue comprises sets of golf clubs that allow a golfer to have a consistent swing among all the clubs. However, these sets of clubs sacrifice maximum efficiency and benefit of each club to achieve the same swing for each club. Additionally, a proper radius and swing circle cannot be achieved for each of the clubs in these sets because the weight, hand height, lie angle and length are not properly coordinated.

What is needed is a set of golf clubs in which all of the clubs are related such that the posture, hand height and swing circle center of the golfer are the same for each club in the set.

### BRIEF DESCRIPTION OF THE DRAWINGS

Further features and advantages of the present device, as well as the structure and operation of various embodiments of the present device, will become apparent and more readily appreciated from the following description of the preferred embodiments, taken in conjunction with the accompanying drawings of which:

FIG. 1 is a view of the locations of the anatomical measurements of a golfer, including the swing radius and the center of the swing circle;

FIG. 2A is a side view of the head of a hand height measuring device used to obtain the correct anatomical measurements of a golfer according to an embodiment;

FIG. 2B is a side view of the head of a hand height measuring device with the shaft swiveled, according to an embodiment;

FIG. 2C is a top view of the head of a hand height measuring device;

FIG. 2D is a view of a telescoping shaft that attaches into the hand height measuring device, according to an embodiment;

FIG. 3A is a side view of a hand height measuring device, according to an embodiment;

FIG. 3B is an enlarged view of the lower part 211 of the hand height measuring device, according to an embodiment;

FIG. 4 is a top view of a fitting board, according to an embodiment;

FIG. 5 is a flowchart illustrating a method for creating a set of golf clubs customized for a golfer's hand height, according to an embodiment;

FIG. 6A is a figure of a triangle representing the hand height, club length and the lie angle of a golf club; and

FIG. 6B is a graph illustrating a relationship between the club length of a club and the lie angle with a constant hand height.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Reference will now be made in detail to the presently preferred embodiments of the invention, examples of which are illustrated in the accompanying drawings, wherein like reference numerals refer to like elements throughout.

The general inventive concept provides a system, method and apparatus for determining the proper size and parameters of a golf club that are needed for each individual golfer, based upon the golfer's hand height. A golfer's hand height is determined as discussed below. When a constant hand height is maintained when holding each of the clubs in a golf set (since each club in the set will be configured to have the same custom hand height), one identical swing, having the proper body balance and posture, can be used for every golf club.

The present system, method and apparatus can be used to find the proper measurements of the golf club prior to the golfer taking a stance. A fitting board can be used to reinforce the correct club position by providing visual indications for the correct stance and allowing the golfer to feel the correct posture for each swing. Certain anatomical features of the golfer can be measured while he or she stands in a neutral, balanced, upright position. The inventive concept described herein can determine what club parameters (club length, lie angle, etc.) produce the most anatomically correct posture and golf swing for a particular individual, based upon that person's hand height.

The present system can obtain certain anatomical measurements of a golfer, which can be used to determine the length of the club allowing the golfer to establish proper control of the golf swing. A fitting board (or mat) can be utilized in this system to reinforce the proper golf club fitting prior to taking a swing stance and also allows the golfer to see and feel the proper duplications necessary to repeat the correct motion from club to club and shot to shot. The system can utilize a hand height measurement tool that can obtain the correct golf club length from measurements based upon specific anatomical features of the body when a person is in a neutral stance.

The present inventive concept is used to determine the proper golf club size for a golfer that assures all portions of the swing circle are aligned with the golfer's center of gravity and that the ball is located at the proper location in the swing circle. The present inventive concept allows the golfer to maintain a neutral body balance while hitting the ball. A person is in neutral body balance position when they are standing in a natural stance that does not require extra effort on the part of the individual to maintain. The fitting/measurement can also assure that the golfer obtains the proper club size, which can allow the golfer to establish proper control of the radius of the golf swing circle as well as proper body balance while swinging a club.

The methods currently used to fit a golfer to a golf club do not use a dynamic, anatomically based system to find the correct club size for a golfer that will allow him or her to control the posture and radius of the swing circle. The laws of physics apply to the pattern of travel created by a golf club and the golfer's arms when hitting the ball in the game of golf. This swinging motion creates a circle, known as the “swing circle,” with the radius comprised mostly of the golfer's arms and the length of the club. The center of the swing circle is located at the midpoint between the golfer's shoulders. The ball can be placed such that it lies on the circumference of the circle. This location will allow the head of the golf club to strike the ball at the correct angle and with the greatest assistance from gravity. Upon the club striking the ball, the ball will travel in a line tangent to the swing circle. Adequate control of the radius of the swing circle allows the golfer to consistently repeat the same swing motion.

The present system can include two different measuring apparatuses. One is a fitting board that can accurately measure certain distances of each individual while he or she is standing in a neutral body balanced stance. A measuring club is also used to measure the height of the circle center of the swing circle for a particular individual.

The present inventive concept relates to a set of golf clubs that are designed such that each club allows the golfer to have the same anatomically correct posture and swing.

Therefore, one purpose of the present set of clubs according the inventive concept described herein is to have each of the clubs in the set related to each other and the golfer's measurements such that they all allow for the same posture and swing motion, which can also be the most anatomically correct posture and swing motion. A correct swing motion has a center of the swing circle located at the midpoint between the golfer's shoulders. The radius of this swing circle comprises the length of the golfer's arm and the length of the club. Therefore, the preferred club length allows the radius to rotate about the swing center and the club head impact the golf ball on the edge of the circle.

The weight, lie angle and length of the clubs are all important characteristics in forming clubs that permit the golfer to repeatedly use the same posture and swing, but each can cause the ball to travel in an unpredictable fashion, if they are not adjusted properly.

Each of the clubs in a set has a different loft angle, which corresponds to its specific purpose. The higher number of the club generally corresponds to a greater loft angle, with the wedges having the greatest angle and the drivers having the least. Longer shafts are used for clubs with smaller loft angles because these clubs generally require more power, which can be achieved by a swing circle having a longer radius. The higher numbered clubs and the wedges have shorter club lengths to give the golfer more control, which is more important in the situations where these clubs are utilized.

According to the present inventive concept, each individual has a specific hand height measured from the ground to the space between the pisiform and triquetrum carpel bones felt on the bottom corner of the palm on the ulna side of the hand to the floor when the body is in a neutral body balance position. A neutral body position can be determined by a person leaning too far to one side until they are off balance and then leaning back to the other side until they are off balance. The standing position wherein the person is comfortable and most resistant to being off balance is neutral body balance position. The hand height is dependent upon a person's height, arm length and posture. This hand height should remain constant for every swing and should not change based upon the club that is being used. A set of golf clubs with the best properties of loft angle, length and lie angle can be produced to allow the golfer to maintain the same posture and swing circle center for every club based on the measured hand height.

The swing weight of the club is also critical when creating a golf club with the best swing properties. The swing weight is different from the overall weight of the club. It is the weight that the golfer feels as he or she is swinging the club. Each club in a set should have the same feeling that is expected by a golfer. Additionally, the weight of the head of a club affects the flexion of the club. The swing weight should be balanced so that the golfer feels the head of the club in the appropriate weight, without regards to its actual weight. The swing weight changes when the length of a club is varied. A longer club length will increase the weight feel of the head that is being used by the golfer during the swing. Therefore, in the present inventive concept, the weight of the head must be decreased to make it feel similar to the other clubs in the set. Likewise, the weight of the head of a shorter club must have a heavier head. Generally, club heads are designed to be heavier for the short clubs, with no possible way to reduce the weight if a longer shaft is needed. The present golf clubs comprise heads that allow their weight to be adjusted.

Each club in the set can have a lie angle and a corresponding club length that allows the player to have the same hand height, posture and swing center no matter which club is being used, which is based on the measured hand height for a golfer. The club specifications should be determined through the use of basic measurements of a person's hand height in neutral standing position. Finally, the clubs should be sized so that the center of the swing circle is located between the golfer's shoulders, and the radius of the circle is comprised of the golfer's arms and the length of the club.

The general inventive concept can also provide a set of clubs that allows the golfer to have the same posture, hand height and swing circle center for each club in the set. The set can also allow each club in the set to maintain the beneficial properties associated with the purpose for each club. The swing circle has a center located between the shoulders of the golfer. This location of the center of the swing circle provides the most anatomically correct swing that utilizes the laws of physics to the best advantage for the golfer. Additionally, the weight of each club head can be adjusted so that the swing weight of each of the clubs is similar and the flexion of the club's shaft can be adjusted to conform to the specifications requested by a golfer.

A golfer desiring to find a properly fitting golf club can stand in a neutral body balance position to find the correct measurements for determining the proper golf club specifications. This stance establishes neutral body balance and center of gravity of the golfer while standing flat-footed. In this position, a measuring club can be used to obtain the hand height of for the golfer. The hand height distance can be determined by measuring the distance between the ground and the pisiform and triquetrum carpal bones of the golfer's primary lever upper hand. The distance determination can be simplified through the use of the hand height measuring club. The hand height distance can correlate to a proper length for the golf club shaft that will properly fit the golfer.

The hand height measuring device (club) can be used to assist with finding the correct hand height and determining other measurements. The device can have a head or simulated head with a shaft attached to the head. The shaft can be attached through the use of a joint that can be pivoted to achieve angles ranging from nearly parallel to the head or ground to perpendicular to the head or ground. The shaft can contain gradient marks that indicate the length of the shaft or distance to the ground, and it can be telescopic. When measuring the hand height distance the golfer can locate the top of the measuring apparatus to the pisiform and triquetrum carpal bone of the golfer's lever upper hand and can allow the head to extend straight down to the floor. Once the correct distance is determined, the measuring device can be locked at the length of the hand height through the use of a locking mechanism.

To find the proper address posture position, the golfer can again establish the neutral body balance and center of gravity standing position with feet flat. The golfer can grip the club with proper hand positioning for a golf swing on the golf club grip. The golfer can then lift his or her arms, club shaft, grip and club head vertically, with arms extended but not rigid, until they are extended outward from the body. The club and arms should be at a ninety-degree angle with respect to the body. Once the arms are in the perpendicular position, the golfer can lower the arms, grip, shaft and club head toward the ground by rotating the shoulder joint until his or her upper arms touch the chest and can not be lowered further. The wrist angle can be neutral and the shaft can line up with the ulna bone of the upper hand. In this position, the club head should be slightly above ground level because the golfer is still in the upright neutral body balanced position. The golfer can then lower the club fully to the ground by bending slightly at the waist and allowing the pelvic girdle to move slightly backward. This motion can lower the swing circle center toward Earth, but does not allow it to move forward, keeping the golfer's center of gravity over his or her feet and maintaining a neutral body balanced position. Simultaneously with the tilt, the golfer can allow the club head, shaft, grip, arms and wrists to fall naturally. The position obtained, properly aligns the center of gravity of the golfer and the swing circle radius, body balance and the club head position to the ball. This method can be repeated several times to ensure comfort and the most natural posture position.

Once in the position outlined above, a fitting board apparatus can be used to indicate the proper location of the golf ball for the specific golfer. After the correct club length is determined, the golfer can stand on the fitting board in a specified location and perform the steps outlined above for lowering the club to the ground. The location where the club contacts the board can indicate the distance away from the golfer that the ball should always be position to create the correct swing circle radius control and plane of swing. This distance is known as the plum to ball address distance. The board can comprise markings to indicate the location where the golfer's feet can be placed and it can also comprise markings that indicate plum to ball distance. The markings used to determine plum to ball distance can be located with the zero distance indicated at the plum line just inside the toes of the golfer, with markings extending straight outward in the direction forward of the golfer with a number of markings at distances where a golf ball might be placed, preferably in half-inch increments. The measurement obtained from the fitting process can be used so that the ball can be positioned correctly in the future.

The fitting board can simplify and reinforce the proper fitting of the golf club in relation to the neutral body balance stance. The fitting board can also have measurements that help to ensure that the golfer has the correct posture and plum to ball address distance. The side of the board can contain a range of hand height measurements and an adjacent side of the board can have a range of plum to ball address distances. A club can be placed with the head sole flat on the ground as it would be in the address position. The club can then be slid along the ground maintaining this angle until the top of the grip reaches the edge of the board. Where the grip intersects with the edge of the board the hand height measurement can be obtained from the range of measurements listed. This measured hand height should correspond to the measured hand height of a golfer to ensure proper golf club fit and stance.

A fitting board can also be used to assist in finding the correct swing circle center height. The fitting board can contain an indication located where the plum line from the swing circle center would intersect the board. The swing circle center measuring device can be used to remind the golfer not to lean forward or reach for the golf ball when lining up and addressing a shot. It can also be used to ensure that the golfer has the same swing neutral body balanced posture position for each club and every stance.

When all parts of the system are utilized together the proper plane of swing position related to the swing circle center can be obtained. Additionally, this correct positioning can be reinforced through the use of several different apparatuses, which allows the golfer to ensure that the proper club fit, posture position, constant hand height and ball position are obtained.

A golfer can be measured using the hand height measuring club to find his or her natural hand height. Hand height can be determined by placing the golfer in neutral body balance, with feet flat on the floor. In this position, the person cannot be easily forced out of balance by forcing his or her weight to move in any direction. The neutral position is one where the body does not feel any pull by gravity except through his or her feet. Once in a neutral body balanced position, the hand height of the golfer can be measured. The hand height is the distance measured from the ground to the pisiform and triquetrum carpal bones (or a point midway between these two bones, or a point in their vicinity) in the palm of the golfer's hand that creates the fulcrum at the butt end of the club. Once the hand height is found, a corresponding club length can be chosen.

A set of clubs can be made to keep the posture and hand height of the golfer the same for each club but also allow the clubs to maintain their specific feel and function. The driver can be made to be the longest club in the set followed by the woods, irons and wedges, with the putter being the shortest club in the set. Once the hand height is determined, a chart specifies the correct club length and lie angle for the particular golfer. Ideally, a 31.5 inch measured hand height corresponds to a 33.5 inch club length for the wedge clubs. From there, the 10 iron increases in length ½ of an inch and the 9 iron is ½ of an inch longer than the 10 iron. The 5-8 irons are each ½ an inch longer than the preceding club and the 2-4 irons are each ½ of an inch longer than the clubs preceding it. An inch increase or decrease in hand height can correspond to an inch increase or decrease in the club length of the wedge clubs. These measurements can allow the golfer to maintain a constant posture and constant hand height swing for every club in the set, but still allow each of the clubs to maintain its specific performance profile.

The hand height location can be the most anatomically correct location to maintain a neutral body balance posture and have the center of the swing circle located directly between the golfer's shoulders. Additionally, because the hand height is kept constant for every club and the length of the club is varied, geometric principles control the address distance, which varies according with each club. Finally, the loft angle of each club can be kept standard so that the path of the golf ball is predictable to the golfer.

The weight of each of the clubs can be varied to maintain a constant swing weight among the clubs of the set. The head can initially be the lightest weight, corresponding to the longest shaft that will be manufactured for that type of club. Additional weight can be added to this club head as the length of the shaft is decreased for golfers that have a shorter hand height. For example, a decrease of ½ inch in the length of the shaft can correspond to an increase of seven grams of head weight. The starting weight for the longest club of each type can be varied in the same fashion. For example, the addition of ½ in length between the eight and seven irons will correspond to a seven-gram decrease in the weight of the head made for the highest hand height. This variation can be continued for the variations in each type of club as discussed above. The flexion of the shaft can be altered per the preference of the particular golfer to maintain proper club head position when the club head contacts the ball.

When the lie angle, club length and head weight are adjusted based upon the hand height measurements, a customized set of golf clubs can be produced for each particular golfer. By using the customized set of clubs, the golfer can maintain a constant posture and constant hand height and constant swing for each club in the set, allowing the golfer to have the most anatomically correct swing with every stroke without regard to the club being used.

FIG. 7 shows one way to measure a club length. One way the club length can be measured is by measuring between a first point and a second point. CL represents club length between the first point and a second point. The second point can be on the butt (very end) of the shaft (without the grip because the grip might add an unwanted extra eighth of an inch). A shaft line is a line that is aligned through the center of the shaft. A second line is at a 45 degree angle to the shaft line and touches a tangent point on the heel of the golf club. The first point is the intersection point between the shaft line and the second line. In other words, the club length can be measured starting at an end point located at the intersection of a shaft axis and a 45 degree angle to the shaft axis at the heel of the club head, and ending at an end point located at the butt (very end) of the shaft. The dotted line in FIG. 7 represents the shaft axis (or shaft line).

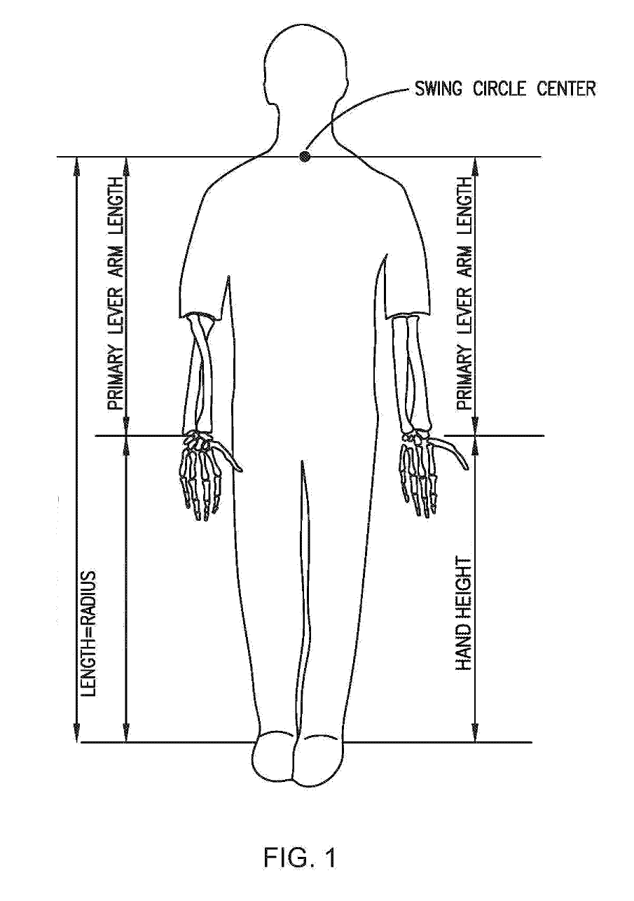

FIG. 1 is a view of the locations of several anatomical measurements of a golfer, including the swing radius and the center of the swing circle.

The length marked “hand height” is the vertical length from the floor to the golfer's pisiform and triquetrum bones.

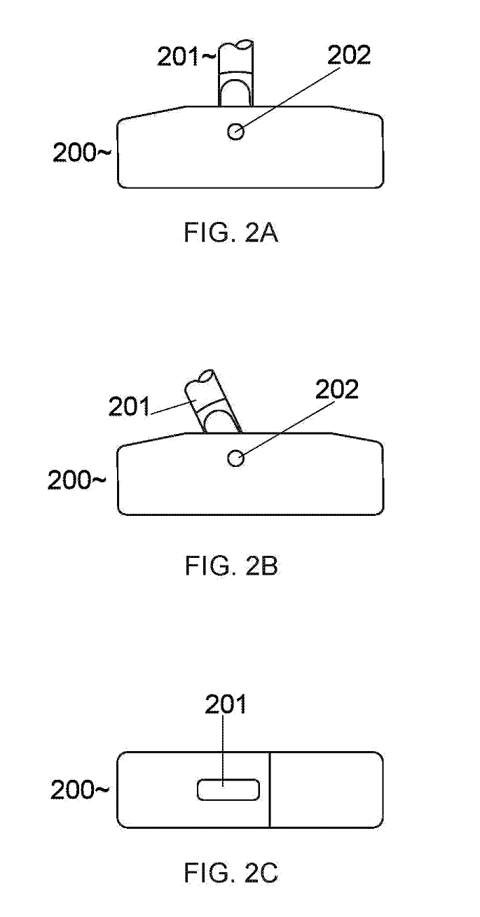

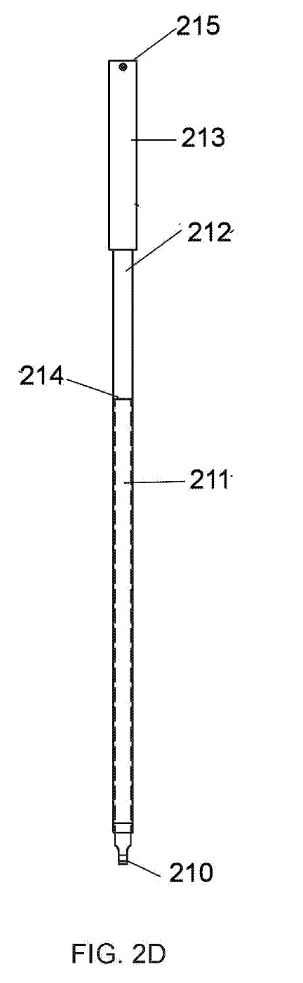

FIG. 2A is a side view of a head of a hand height measuring device used to obtain the correct anatomical measurements of a golfer according to an embodiment. The hand height measuring device is also referred to herein as a measuring device or a measuring club.

A club head 200 has a connected shaft 201 with a swivel point 202 so that the shaft 201 can swivel around the swivel point 202.

FIG. 2B is a side view of the head of the hand height measuring device with the shaft swiveled according to an embodiment.

The shaft 201 is shown rotated (“swiveled”) around the swivel point 202. The purpose of this swivel is to allow the measuring device to accommodate different lie angles.

FIG. 2C is a top view of the head of the hand height measuring device.

The shaft 201 and the club head 200 are shown.

FIG. 2D is a view of a telescoping shaft that attaches into the head of the measuring device according to an embodiment.

An end 210 of the telescoping shaft screws into the club head 200 (not pictured in FIG. 2D but would be attached when the measuring device is used) or is otherwise connected to the club head 200. An upper part 212 of the telescoping shaft slides (telescopes) over a lower part 211 of the telescoping shaft, in other words the lower part 211 can slide upward (into) the upper part 212. The lower part 211 has numbers marked on it (not shown in FIG. 2D), which indicates a hand height of the golfer. A grip 213 is attached to the upper part 212 and is used by the golfer (not pictured) to grip the measuring device (and more specifically, the upper part 212).

Thus, the golfer grips the measuring device at the grip 213 (like he/she would with any other club), and stands in a neutral body balance, with feet flat on the floor. In this position, the golfer cannot be easily forced out of balance by forcing his or her weight to move in any direction. The neutral position is one where the body does not feel any pull by gravity except through his or her feet. Once in a neutral body balanced position, the hand height of the golfer can be measured. The hand height is the distance measured from the ground to the pisiform and triquetrum carpal bones in the palm of the golfer's upper hand. The lower part 211 is raised into the upper part 212 and the golfer grips the grip 213 so that the top 215 of the grip 213 coincides with the golfer's pisiform and triquetrum bones. The lower part 211 is then released out of the upper part 212 and the lower part 211 extends toward the ground so that the club head (attached to the end 210) rests on the ground. An edge 214 of the upper part 212 is used to read the numbers on the lower part 211. The number on the lower part 211 that is positioned where the edge 214 when the grip/upper part is positioned so that the top 215 of the grip 213 matches the location of the golfer's pisiform/triquetrum bones and would be the measured hand height.

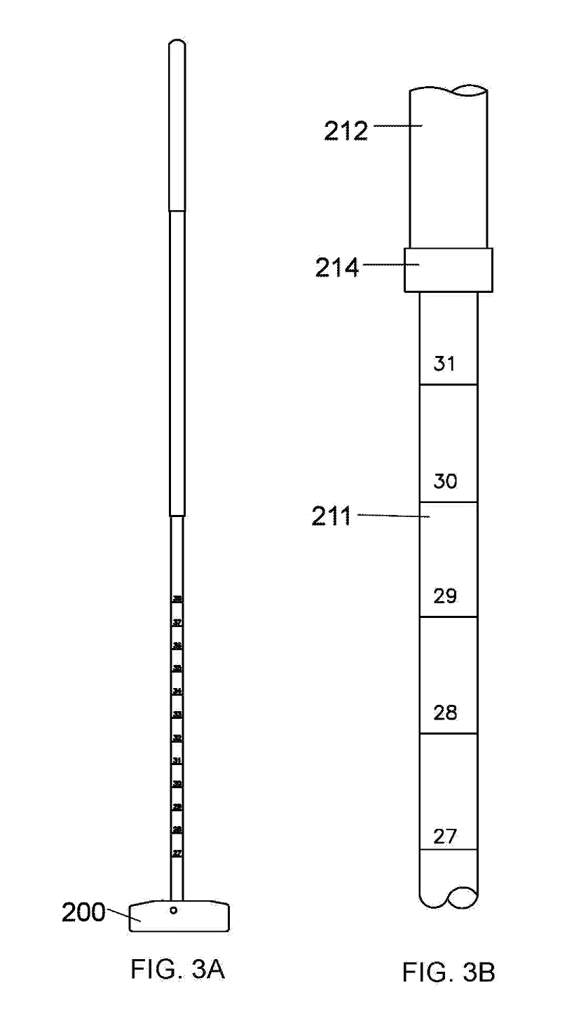

FIG. 3A is a side view of a measuring device according to an embodiment.

In this view, the end 210 of the telescoping shaft has been screwed into the club head 200.

FIG. 3B is an enlarged view of the lower part 211 of the measuring device. The lower part 211 has numbers which represent hand heights. The upper part 212 and edge 214 slide over the lower part 211 as the grip is being adjusted to the proper position, which matches the golfer's pisiform/triquetrum bones. The number positioned where the edge 214 is when the grip is in its proper position is the hand height. In this example, the hand height is measured to be approximately 32 inches.

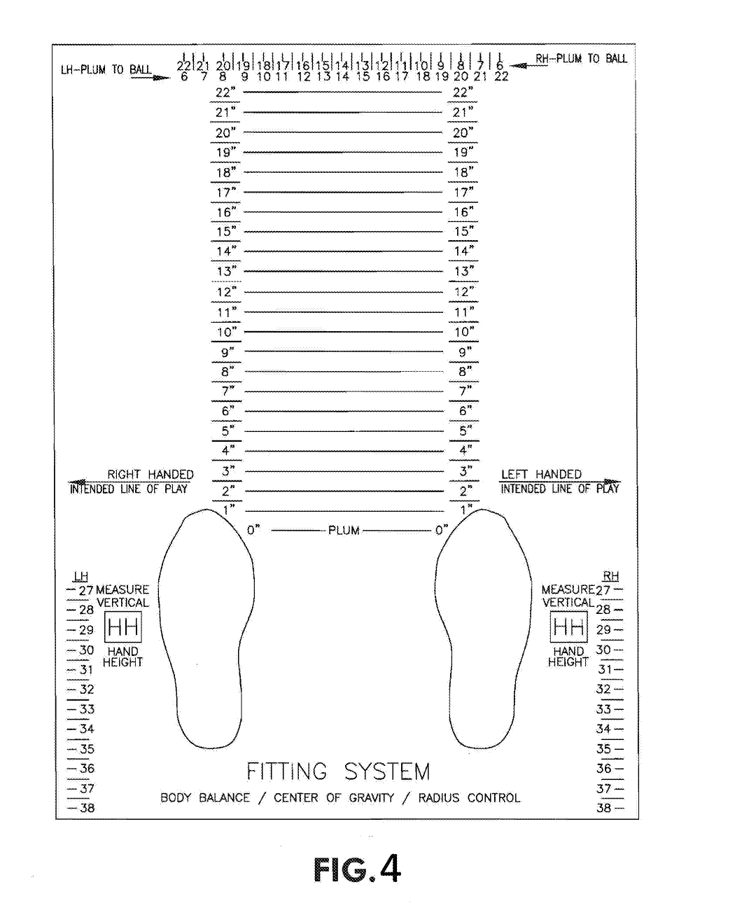

FIG. 4 is a top view of a fitting board according to an embodiment.

A fitting board 400 can be made of cardboard, plastic, or other durable material and can have the indicia on it as illustrated. The golfer can place his feet on the foot marking on the fitting board 400 and practice his/her swing.

The plum to ball measurement is taken from the center of the golf ball to the plum line of the butt of the club. The measuring device can be used to measure the plum to ball. The plum to ball measurement is determined by the lie angle and the length of the shaft. The measuring club can take on any lie angle (since it swivels).

Thus, the fitting board can be used by golfers to try out potential clubs to see if a particular club has a desirable length (and feel).

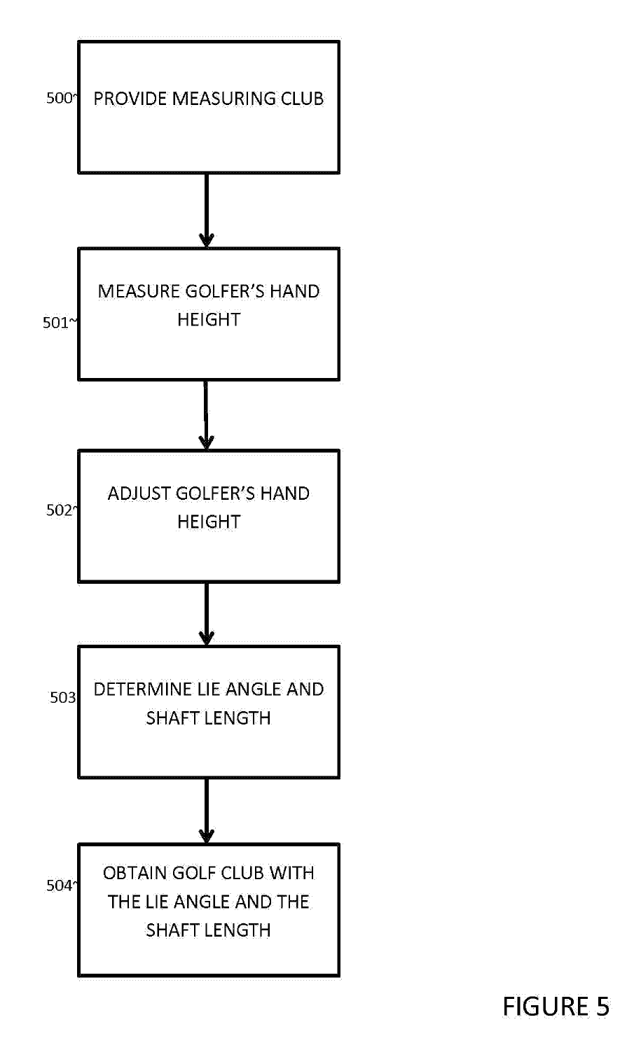

FIG. 5 is a flowchart illustrating a method of creating a set of golf clubs customized for a golfer's hand height, according to an embodiment.

The method can begin with operation 500, which provides the measuring club used to measure the hand height of the golfer. The measuring club is illustrated in FIGS. 2A-2D and 3A-3B. The method herein can be implemented by a golf professional who is measuring a golfer for customized clubs. The professional can be, for example, working in a golf store.

From operation 500, the method proceeds to operation 501, which actually measures the golfer's hand height. The head of the measuring club is laid flat on the ground, the golfer puts his hands on the grip while maintaining a neutral body position. The golfer stands with eyes straight ahead, erect but not rigid, arms hanging down, hands at military attention and knees not bent. The golfer grips the grip 213 with his pisiform and trequetrum bones approximately located at the top 215 of the grip 213. If the golfer is not sure where these bones are then he can grip the grip 213 placing his/her wrist at the top 215. The bone heights are measured from the ground. The measuring club is used and the lower part 211 is then lowered to the ground, and a measurement is taken using the corresponding number on the shaft where the edge 214 is located.

From operation 501, the method proceeds to operation 502, which adjusts the measured hand height measured in operation 501. Once the measured hand height is taken, this can be adjusted by subtracting 1.25 to 1.5 inches from the hand height to create an adjusted hand height. This adjusts for when the golfer bends at his or her waist while addressing the ball into the stance posture. For example, for every golfer who is measured, the measured hand height can be reduced by 1.5 inches to adjust for the lower position of the golfer's hands after the golfer bends at his/her waist.

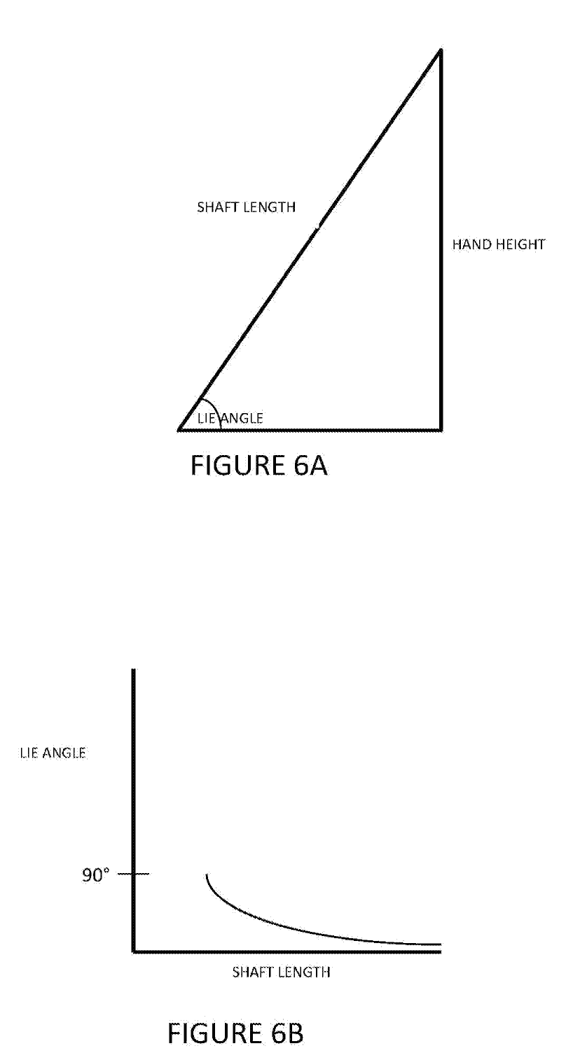

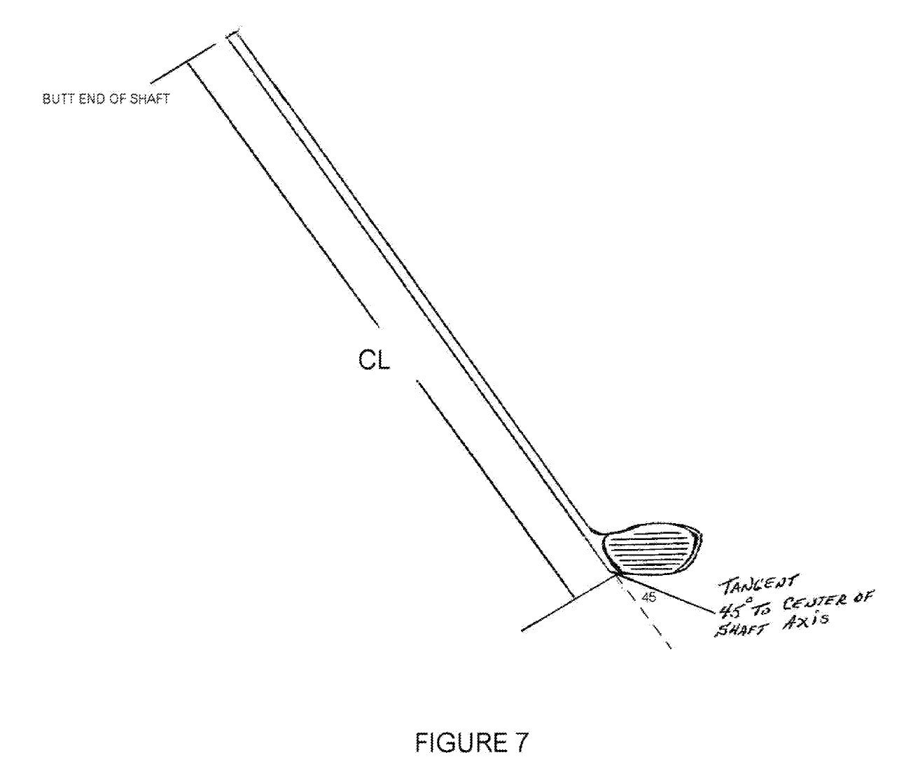

From operation 502, the method proceeds to operation 503, which determines the lie angle and the club length of the new club. The lie angle and club length can be determined using trigonometry (see FIGS. 6A-6B). There is no one specific combination of lie angle and club length that must be used, rather there are different combinations of the two parameters with the limitation that the sine(lie angle) equals or approximately equals the adjusted hand height/the club length. Thus, in other words, knowing one parameter (the club length or the lie angle) the other parameter can be easily computed using the formula. In one embodiment, a chart can be used of different club lengths for different type of clubs, and using these club lengths the respective lie angle can be computed. For example, a chart can indicate that for someone with an adjusted hand height of 31.55, for a 2-iron club, a club length can be 38. This club length would be different for different clubs (e.g., 3 iron, pitching wedge, etc.). The club lengths in the chart may be considered preferred club lengths for each type of club, although some golf professionals (or golfers) may prefer other lengths and there is no set of club lengths that is set in stone as the best ones. Therefore, there is some leeway to adjust club lengths/lie angles in order to come up with a new club that is best for each individual golfer (as long as they both satisfy the mathematical relationship). Thus, a golf club with a club length and lie angle that meet the mathematical relationship (sine(lie angle) equals or approximately equals the adjusted hand height/the club length) is considered to be configured for that hand height. Different clubs (e.g., three iron, four wood, etc.) that are configured for the same constant hand height would provide the golfer the ability to use the same stance posture for each of the different clubs, which would typically be easier for a golfer and allow for the use of a consistent swing.

In one embodiment, a golfer can be presented with three (or other number) of different clubs with different club lengths, and the golfer (and professional golfer performing the fitting) can choose which of the three clubs he/she feels has the best feel. Each club customized for the golfer would have the lie angle configured with the club length to meet the mathematical relationship.

From operation 503, the method proceeds to operation 504 wherein the professional obtains the golf club with the lie angle and club length computed form operation 503. This can be obtained in numerous ways. For example, the golf store can stock many different types of clubs with various lengths/lie angles and the needed club (that matches or approximately matches the parameters) can be used. Or, the professional (typically in a golf store) can have machinery that can customize golf clubs by setting the lie angle (using a bending machine) and cutting the shaft (using a metal cutter such as a graphite saw) to the desired length. Or, the golf store can order clubs with the desired parameters from a supplier who can make the clubs and deliver them to the store.

Operations 503-504 can be repeated for each different type of club needed. In the end, an entire standard set of constant hand height clubs can be obtained for the golfer. Each of these clubs would typically have different club lengths and lie angles, but all of the clubs are designed (configured) for the same adjusted hand height (thus each lie angle/club length of each club satisfies the mathematical relationship described above, that is that the sine(lie angle) equals or approximately equals the adjusted hand height/the club length). A standard set consists of 14 golf clubs, typically consisting of 3 or 4 woods, 7 or 8 irons, a wedge and a putter. While it is ideal that all golf clubs in a golf bag used by a player are configured for the same constant hand height, in an embodiment some (but not all) clubs in the bag can be configured for the same hand height while some are not. Any number of clubs in the bag used by the golfer can be configured for the same hand height (e.g., two up to 14 for a standard bag of clubs or more clubs (as many as the golfer has).

Previously, no manufacturer has ever made a set of clubs configured for the same constant hand height (that meet the mathematical relationship illustrated in FIGS. 6A and 6B) within the set. Instead, they have adopted lie angles, weights, etc. which are controlled by the same spec numbers. Thus, players are forced to stand in different postures with different hand heights for each of the different clubs in the set.

As a result of the present inventive concept, a golfer can walk into a golfing store (or any store), and have his/her hand height measured. Based on a function of the hand height, the golfer can purchase a set of (any number from 2-20 or more) golf clubs all configured for that same constant hand height. The golfer can receive the purchased set immediately at the store, he may have to come back to the store when the set of clubs have all been obtained by the store, or the golfer may receive the set in the mail.

Table I is a list of specifications for a set of constant hand height golf clubs, including lie angle and club length for an adjusted hand height of 31.5 inches according to an embodiment. Other parameters of the club (e.g., loft angle) can be configured as standard clubs.

TABLE 1
Height 31.5″

| Club | Lie angle (°) | Club length (″) |
|---|---|---|
| 2I | 55.99 | 38 |
| 3I | 57.38 | 37.4 |
| 4I | 58.8 | 36.82 |
| 5I | 60.28 | 36.27 |
| 6I | 61.79 | 35.74 |
| 7I | 63.36 | 35.24 |
| 8I | 64.96 | 34.76 |
| 9I | 66.61 | 34.32 |
| 10I | 68.3 | 33.9 |
| P | 70.1 | 33.5 |
| G | 70.1 | 33.5 |
| S | 70.1 | 33.5 |

Table II is a list of specifications for a set of constant hand height golf clubs, including lie angle and club length for an adjusted hand height of 32.5 inches according to an embodiment. Other parameters of the club (e.g., loft angle) can be configured as standard clubs.

TABLE II
Height 32.5″

| Club | Lie angle (°) | Club length (″) |
|---|---|---|
| 2I | 56.44 | 39 |
| 3I | 57.81 | 38.4 |
| 4I | 59.22 | 37.82 |
| 5I | 60.67 | 37.27 |
| 6I | 62.17 | 36.75 |
| 7I | 63.71 | 36.25 |
| 8I | 65.29 | 35.77 |
| 9I | 66.91 | 35.33 |
| 10I | 68.57 | 34.91 |
| P | 70.4 | 34.5 |
| G | 70.4 | 34.5 |
| S | 70.4 | 34.5 |

Table III is a list of specifications for a set of constant hand height golf clubs, including lie angle and club length for an adjusted hand height of 33.5 inches according to an embodiment. Other parameters of the club (e.g., loft angle) can be configured as standard clubs.

TABLE III
Height 33.5″

| Club | Lie angle (°) | Club length (″) |
|---|---|---|
| 2I | 56.88 | 40 |
| 3I | 58.24 | 39.4 |
| 4I | 59.65 | 38.82 |
| 5I | 61.09 | 38.26 |
| 6I | 62.58 | 37.73 |
| 7I | 64.11 | 37.23 |
| 8I | 65.68 | 36.76 |
| 9I | 67.29 | 36.31 |
| 10I | 68.94 | 35.89 |
| P | 70.68 | 35.5 |
| G | 70.68 | 35.5 |
| S | 70.68 | 35.5 |

Table 4 is a list of specifications for a set of constant hand height golf clubs, including lie angle and club length for an adjusted hand height of 34.5 inches according to an embodiment. Other parameters of the club (e.g., loft angle) can be configured as standard clubs.

TABLE 4
Height 34.5″

| Club | Lie angle (°) | Club length (″) |
|---|---|---|
| 2I | 57.29 | 41 |
| 3I | 58.64 | 40.4 |
| 4I | 60.03 | 39.82 |
| 5I | 61.46 | 39.27 |
| 6I | 62.93 | 38.74 |
| 7I | 64.44 | 38.24 |
| 8I | 65.98 | 37.77 |
| 9I | 67.57 | 37.32 |
| 10I | 69.19 | 36.9 |
| P | 70.94 | 36.5 |
| G | 70.94 | 36.5 |
| S | 70.94 | 36.5 |

Table V is a list of specifications for a set of constant hand height golf clubs, including lie angle and club length for an adjusted hand height of 35.5 inches according to an embodiment. Other parameters of the club (e.g., loft angle) can be configured as standard clubs.

TABLE V
Height 35.5″

| Club | Lie angle (°) | Club length (″) |
|---|---|---|
| 2I | 57.7 | 42 |
| 3I | 59.04 | 41.39 |
| 4I | 60.43 | 40.81 |
| 5I | 61.85 | 40.26 |
| 6I | 63.31 | 39.73 |
| 7I | 64.81 | 39.22 |
| 8I | 66.35 | 38.75 |
| 9I | 67.93 | 38.3 |
| 10I | 69.54 | 37.89 |
| P | 71.2 | 37.5 |
| G | 71.2 | 37.5 |
| S | 71.2 | 37.5 |

Table VI is a list of specifications for a set of constant hand height golf clubs, including lie angle and club length for an adjusted hand height of 36.5 inches according to an embodiment. Other parameters of the club (e.g., loft angle) can be configured as standard clubs.

TABLE VI
Height 36.5″

| Club | Lie angle (°) | Club length (″) |
|---|---|---|
| 2I | 58.09 | 43 |
| 3I | 59.42 | 42.4 |
| 4I | 60.78 | 41.82 |
| 5I | 62.19 | 41.26 |
| 6I | 63.63 | 40.74 |
| 7I | 65.11 | 40.23 |
| 8I | 66.63 | 39.76 |
| 9I | 68.18 | 39.31 |
| 10I | 69.77 | 38.9 |
| P | 71.45 | 38.5 |
| G | 71.45 | 38.5 |
| S | 71.45 | 38.5 |

In an embodiment, a golf store can stock a large quantity of each of the golf club sets described in Tables I, II, III, IV, V, and VI. A customer (golfer) could come in, have their hand height measured, then the adjusted hand height determined, and then a set would be chosen closest to the adjusted hand height (for example, if the adjusted hand height is 35.1 then the set of Table V can be used). The customer can then be sold such a set of clubs (which contain 12 different clubs). Of course, the store can sell any other number of clubs as a set (e.g., 10) instead of 12, and in any combination of clubs (e.g., one set could consist of just a pitching wedge, three irons, two woods, etc.)

It is noted that each of the clubs in each set of Tables I-VI (each table being a set) satisfy the mathematical relationship (sin(lie angle) equals or approximately equals the adjusted hand height/the club length). The numbers in the tables might not come out exactly as expected due to rounding. Similarly, the actual physical measurements of parameters of the actual clubs (e.g., lie angle, club length) may approximate their expected measurements but due to manufacturing issues might not be exactly equal to the expected value (e.g. the length may be off by one fifth (or one tenth, one fifteenth, etc.) of an inch or so). It is also noted that other parameters of the clubs in the tables (e.g., loft angle) can be configured as known in the art. Thus, even though the length and the lie angles of the pitching wedge, gap wedge, and sand wedge are identical, the loft angles of each of these clubs would be different and thus these are different clubs.

It is noted that for each successive club in the Tables, each club is slightly shorter. This is because the longer a club is, typically the faster the club head will strike the ball, however the longer the club is the more difficult it will be for the golfer to swing the club accurately. Accuracy is a function of steady swing circle center, constant radius and squareness of the club face at impact. Thus, the set of clubs configured to a constant custom hand height will help the golfer establish their swing center, constant radius, and posture, which will allow them to consistently contact the ball at the center of gravity. Note that the last three clubs (pitching wedge, gap wedge, sand wedge) have the same club length/lie angle. Typically, it is not desirable to have a club length shorter than the measured hand height (which might be 1.5 to 2 inches higher than the adjusted hand height).

FIG. 6A is a figure of a triangle representing the hand height, club length of a club, and the lie angle.

A triangle has a leg (vertical) representing the hand height and a hypotenuse representing the club length. The hand height is actually the adjusted hand height (1.5 to 2 inches subtracted from the measured hand height). The lie angle can be computed by the following trigonometric relationship (sine of course referring to the trigonometric function)

sine(lie angle)=hand height/club length.

The bottom left corner of the triangle represents where the club head and ball would be at the point of impact, the bottom right corner of the triangle represents the golfer's feet, and the top right corner of the triangle represents where the golfer's hands are. The distance of the bottom leg represents the “plum to ball” distance (the distance from the golfer's feet to the club head/ball).

FIG. 6B is a graph illustrating a relationship between the club length of a club and the lie angle with a constant hand height. The x-axis of the graph represents the club length and the y-axis represents the lie angle. The y-axis plots the function: y=arcsin(31.5/x), wherein this graph is for an adjusted hand height of 31.5 inches. Of course different such graphs can be devised for different hand heights. As can be seen, there are many combinations of club lengths and lie angles that can be used for a given hand height (or adjusted hand height). The plot ends abruptly on the left side where the club length is less than the hand height because this would require an “impossible” angle.

The present inventive concept provides for a set of golf clubs that will be used by golfers to ensure the proper posture and golf swing with the correct position of the center of the swing circle. This set of clubs can allow a golfer to have the same swing posture for each club in the set. The length of the clubs and the lie angle of each can be varied allowing the individual clubs to retain their expected performance with all clubs in the set being capable of proper actuation by the same swing. Additionally, the clubs can be balanced so that the swing weight of every club is identical and each club feels the same to the golfer.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method to produce a custom golf club, the method comprising:
providing a measuring club comprising:
a club head;
a telescoping shaft connected to the club head, the telescoping shaft comprising indicia representing a hand height;
measuring a golfer's hand height with the measuring club;
adjusting the hand height to create an adjusted hand height;
determining a lie angle and a club length consistent with the adjusted hand height such that sin(lie angle) approximately equals the adjusted hand height/the club length; and
obtaining a golf club formed with the lie angle and the club length.

2. The method as recited in claim 1, further comprising repeating the determining and obtaining for a plurality of additional golf clubs.

3. The method as recited in claim 2, further comprising placing the golf club and additional golf clubs into a single golf club bag.

4. The method as recited in claim 2, further comprising selling the golf club and additional golf clubs to the golfer.

5. The method as recited in claim 1, wherein the obtaining comprises custom machining the golf club to match the lie angle and the club length.

6. The method as recited in claim 1, wherein the obtaining comprises ordering the golf club with the lie angle and the club length.

7. The method as recited in claim 2, wherein the additional golf clubs comprise at least one wood and one iron.

8. A method, comprising:
taking custom measurements of a golfer; and
selling the golfer a plurality of golf clubs, each of the plurality of golf clubs having a respective lie angle and club length configured such that sin(lie angle) approximately equals a constant adjusted hand height/the club length, each of the plurality of golf clubs being different from others in the plurality of golf clubs.

9. The method as recited in claim 8, wherein the constant adjusted hand height is determined by taking a specific measurement of the golfer and adjusting the measurement.

10. The method as recited in claim 8, wherein the plurality of golf clubs comprises a wood and an iron.

11. The method as recited in claim 8, wherein the plurality of golf clubs comprises seven golf clubs.

12. The method as recited in claim 8, wherein the plurality of golf clubs belong to a set of clubs, and a store performing the method stocks a plurality of sets for each of a plurality of adjusted hand heights, wherein all clubs in each set have a respective lie angle and club length configured such that sin(lie angle) approximately equals a constant adjusted hand height/the club length.

13. An apparatus, comprising:
a golf ball bag; and
a plurality of golf clubs inside the bag, each of the plurality of golf clubs having a respective lie angle and club length configured such that sin(lie angle) approximately equals a constant adjusted hand height/the club length, each of the plurality of golf clubs being different from others in the plurality of golf clubs.

14. The apparatus as recited in claim 13, wherein the constant adjusted hand height is determined using a specific measurement of a golfer that owns the bag and the golf clubs.

15. The apparatus as recited in claim 13, wherein the plurality of golf clubs comprises a wood and an iron.

16. The apparatus as recited in claim 13, wherein the plurality of golf clubs comprises at least seven golf clubs.
